(19) United States
(12) Patent Application Publication
(10) Pub. No.: US 2010/0288738 A1
(43) Pub. Date: Nov. 18, 2010

(54) WELDING APPARATUS AND METHOD

(75) Inventors: Marshall Gordon Jones, Scotia, NY (US); Stanley Frank Simpson, Simpsonville, SC (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/466,399

(22) Filed: May 15, 2009

(51) Int. Cl. B23K 26/00

(52) U.S. Cl. 219/121.63; 219/121.64

(57) ABSTRACT

A welding apparatus includes a primary laser generator for emitting a primary laser beam; an arc welding power source; a consumable filler electrode; and at least one secondary laser generator for emitting a secondary laser beam. The primary laser generator, the arc welding power source, and the consumable filler electrode together form a hybrid laser welding system. The secondary laser beam impinges on a weld area before, after, or before and after focusing the hybrid laser welding system at the weld area. A welding method is also provided.

### BACKGROUND

The invention relates generally to the field of welding. In particular, the invention relates to a laser used in a welding apparatus. The invention also provides a method for welding.

Conventional hybrid laser welding systems consist of a single laser source coupled with an arc welding source. The arc welding source, such as a gas-metal arc welding source, enables the introduction of a material that can enhance the metallurgical integrity of the weld structure. When performing a welding operation, for certain materials preheating may be required, for certain materials post heating may be required, and for certain other materials pre and post heating may be required. Preheating of the material may slow the cooling rate in the weld area. Slow cooling in the weld area may be necessary to avoid the formation of cracks in the weld joint or heat affected zone. Formation of cracks typically results in a defective weld joint. The need for the preheat increases with thickness of the material, thermal stresses, and the diffusible hydrogen of the weld metal. On the other hand post weld heating of the weld joint after the welding process may assist in minimizing the high level residual stresses that may occur in the weld area after the welding process due to restraint by the material during weld solidification. The stresses may be as high as the yield strength of the material itself. Post weld heating may reduce the amount of hardness in the weld and the heat affected zone. Generally, preheating and post heating are accomplished by methods including furnace treatment, induction heating, blanket heating, and flame heating. However, these methods are not selective enough.

Typically the preheating and post weld heating requirements have been addressed by preheating the whole component or part to be welded, prior to or after the laser welding process, resulting in an increase in cycle time and reduction of throughput. Also, heating the entire component or part may result in an overall distortion of the component or part. Further, the welding costs are higher due to the cost incurred in heating the entire component or part to be welded. Accordingly, there remains a need for an improved welding apparatus and welding method that may address one or more of the problems set forth above.

### BRIEF DESCRIPTION

In one embodiment, a welding apparatus is provided. The welding apparatus includes a primary laser generator for emitting a primary laser beam; an arc welding power source; a consumable filler electrode; and at least one secondary laser generator for emitting a secondary laser beam. The primary laser generator, the arc welding power source, and the consumable filler electrode together form a hybrid laser welding system.

In another embodiment, a welding apparatus is provided. The welding apparatus includes a primary laser generator for emitting a primary laser beam; an arc welding power source; a consumable filler electrode; and at least one secondary laser generator for emitting a secondary laser beam. The primary laser generator, the arc welding power source, and the consumable filler electrode together form a hybrid laser welding system. The secondary laser beam is focused on a weld area before focusing the hybrid laser welding system at the weld area.

In another embodiment, a welding apparatus is provided. The welding apparatus includes a primary laser generator for emitting a primary laser beam; an arc welding power source; a consumable filler electrode; and at least one secondary laser generator for emitting a secondary laser beam. The primary laser generator, the arc welding power source, and the consumable filler electrode together form a hybrid laser welding system. The secondary laser beam is focused on a weld area after focusing the hybrid laser welding system at the weld area.

In yet another embodiment, a welding apparatus is provided. The welding apparatus includes a single laser generator for emitting a single laser beam. The welding apparatus further includes a beam splitting apparatus to split the single laser beam into a primary laser beam and a secondary laser beam. The welding apparatus also includes an arc welding power source, and a consumable filler electrode. A portion of the beam splitting apparatus emitting the primary laser beam, the arc welding power source, and the consumable filler electrode together form a hybrid laser welding system.

In still yet another embodiment, a welding method is provided. The welding method includes the steps of providing a primary laser generator for emitting a primary laser beam, providing an arc welding power source, providing a consumable filler electrode, and providing at least one secondary laser generator for emitting a secondary laser beam. The primary laser generator, the arc welding power source and the consumable filler electrode together form a hybrid laser welding system.

In still yet another embodiment, a welding apparatus is provided. The welding apparatus includes a primary laser generator for emitting a primary laser beam, wherein the primary laser generator is selected from one or more of neodymium:yttrium-aluminum-garnet laser, ytterbium fiber coupled diode laser, and carbon dioxide lasers; and a secondary laser generator for emitting a secondary laser beam, wherein the secondary laser generator is selected from one or more of neodymium:yttrium-aluminum-garnet laser, ytterbium fiber coupled diode laser, and carbon dioxide lasers; wherein the secondary laser beam impinges on a weld area before focusing the primary laser beam at the weld area, after focusing the primary laser beam at the weld area, or before and after focusing the primary laser beam at the weld area.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a welding apparatus in accordance with one embodiment of the invention;

FIG. 2 illustrates a welding apparatus in accordance with one embodiment of the invention;

FIG. 3 illustrates a welding apparatus in accordance with one embodiment of the invention;

FIG. 4 illustrates a welding apparatus in accordance with one embodiment of the invention; and

FIG. 5 illustrates a welding apparatus in accordance with one embodiment of the invention.

### DETAILED DESCRIPTION

Embodiments of the invention described herein address the noted shortcomings of the state of the art. As described in detail below, embodiments of the present invention provide a welding apparatus and a welding method. The disclosed idea addresses selective heating of components or parts as compared to bulk heating of such parts. When welding components are made using certain metals, it has been shown that the integrity of the weld can be enhanced if the welding process of the components takes place at a temperature higher than ambient conditions, thus requiring some level of preheating. Embodiments of the present invention address preheating and post weld heating of the components to be welded, by using a secondary laser beam in addition to a primary laser beam wherein the primary laser beam is being used to affect the weld. The secondary laser beam may be configured to lead, to follow, or to lead and follow the primary laser beam. If the secondary laser beam leads the primary laser beam the secondary laser beam is focused on the weld area before the primary laser beam is focused on the weld area and functions to preheat the weld area. Alternatively if the secondary laser beam follows the primary laser beam the secondary laser beam is impinged on the weld area after the primary laser beam and functions to post heat the weld area.

Preheating of the weld area before the welding process may assist the welding laser beam, in this case the primary laser beam, in coupling more efficiently with the weld area. On the other hand post weld heating of the weld joint after the welding process may assist in minimizing residual stresses that may occur in the weld area after the welding process due to restraint by the material during weld solidification. Post weld heating may reduce the amount of hardness in the weld and the heat affected zone.

In certain embodiments, secondary laser beams may be employed to preheat and post heat the weld area. Since the weld area is being selectively preheated and post heated the weld area joint may stay at an elevated temperature even longer. The secondary laser beam may be positioned over the weld joint at varying distances between the primary laser beam and the secondary laser beam such that the preheating or post weld heating provided by the secondary laser beam is optimized. Furthermore, since the weld area is being selectively preheated or post heated, the welded joint may stay at an elevated temperature following solidification of the weld area, thus minimizing the tendency of crack formation in crack sensitive materials.

In various embodiments, the primary laser beam and the secondary laser beam may be brought to bear on a weld joint to enable welds of higher quality. Furthermore, complete components or parts may not require preheating or post weld heating. With selective preheating, the welding cycle time could be decreased which would lead to a higher throughput. Also, with selective preheating the amount of post weld heat treatment which is typically carried out in conventional welding methods, may be substantially reduced. Furthermore, there may be less overall distortion of the metals when comparing selective heating versus total component heating. Selective heating also results in a reduction in welding costs per welded component assembly. In certain embodiments, the welding apparatus and method may be used to make components, for example, a cylinder head-liner assembly for use in a locomotive, assembled rotating components for use in the energy industry, piping assemblies for use in the oil and gas industry, and wind tower fabrication.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

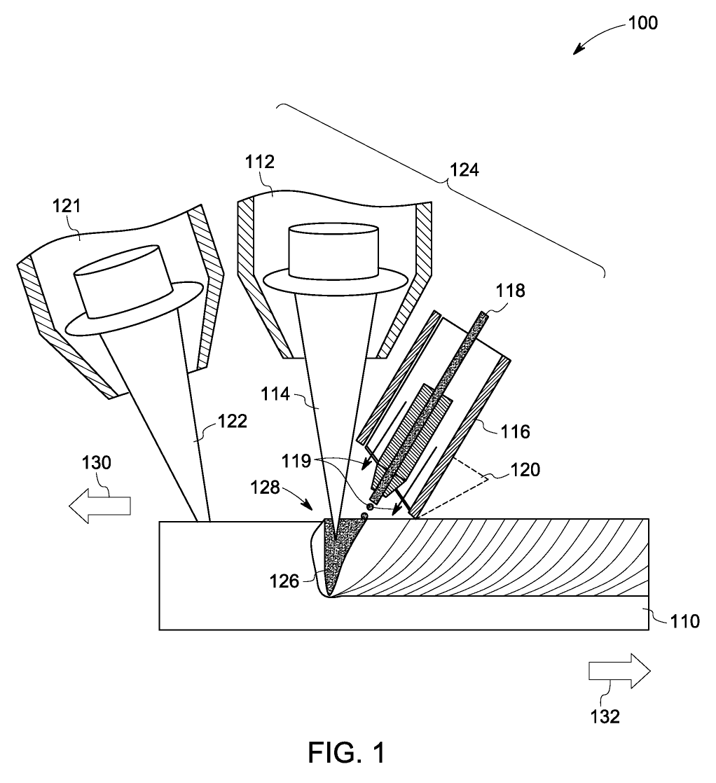

In an illustrated embodiment of the invention as shown in FIG. 1, a welding apparatus 100 is depicted. In the illustrated embodiment, the welding apparatus 100 is used to perform a welding operation on a substrate 110. The welding apparatus 100 includes a primary laser generator 112 for emitting a primary laser beam 114, an arc welding power source 116, a consumable filler electrode 118, a nozzle 120 for passing shielding gas (not shown in figure), a source of shielding gas 119 surrounding the consumable filler electrode 118, and at least one secondary laser generator 121 for emitting a secondary laser beam 122. The primary laser generator 112, the arc welding power source 116, and the consumable filler electrode 118 together form a hybrid laser welding system 124. A weld joint 126 is formed at a weld area 128 in the substrate 110. The secondary laser beam 122 impinges upon the substrate 110, thus pre heating the weld area 128 before the primary laser beam 114 is focused over the weld area 128.

In one embodiment, the primary laser beam 114 and the secondary laser beam 122 have the same wavelength. In an exemplary embodiment, the primary laser beam 114 and the secondary laser beam 122 have a wavelength in a range from about 1060 nanometers to about 10060 nanometers. In another embodiment, the primary laser beam 114 and the secondary laser beam 122 have a wavelength in a range from about 1200 nanometers to about 9000 nanometers. In yet another embodiment, the primary laser beam 114 and the secondary laser beam 122 have a wavelength in a range from about 1065 nanometers to about 1075 nanometers.

For example, the primary laser generator 112 may be selected from one or more of neodymium:yttrium-aluminum-garnet laser, ytterbium fiber coupled diode laser, and carbon dioxide lasers. In embodiments wherein the primary laser beam 114 and the secondary laser beam 122 have the same wavelength the secondary laser generator 121 may be selected from one or more of neodymium:yttrium-aluminum-garnet laser, ytterbium fiber coupled diode laser, and carbondioxide lasers.

In another embodiment, the primary laser beam 114 and the secondary laser beam 122 have a different wavelength. In an exemplary embodiment, the primary laser beam 114 has a wavelength in a range from about 1060 nanometers to about 10060 nanometers. In another embodiment, the primary laser beam 114 and the secondary laser beam 122 have a wavelength in a range from about 1200 nanometers to about 9000 nanometers. In yet another embodiment, the primary laser beam 114 and the secondary laser beam 122 have a wavelength in a range from about 1065 nanometers to about 1075 nanometers. In one embodiment, the secondary laser beam 122 has a wavelength in a range from about 600 nanometers to about 900 nanometers. In another embodiment, the secondary laser beam 122 has a wavelength in a range from about 650 nanometers to about 850 nanometers. In yet another embodiment, the secondary laser beam 122 has a wavelength in a range from about 700 nanometers to about 800 nanometers. For example, the secondary laser generators 121 may be selected from one or more of a diode type laser that emit a laser beam with a wavelength from 600 to 900 nanometers and have a suitable power density for heating ranges of between about 10⁴ watts per square centimeter to about 10⁵ watts per square centimeter. The diode lasers couple effectively to most metals and the beam can easily be configured into desired heating shapes, such as for example, circular shape and rectangular shape. The shape of the laser beam may be tailored according to the width and cross-section of the substrate to be preheated or post heated. Examples of other suitable lasers include neodymium:yttrium-aluminum-garnet laser, ytterbium fiber coupled diode laser, and carbondioxide lasers.

In the embodiment illustrated in FIG. 1, the secondary laser beam 122 impinges on the substrate 110 before focusing the primary laser generator 124 at the weld area 128, wherein the secondary laser beam 122 preheats the weld area 128 before the primary laser generator 100 comes in contact with the weld area. As used herein the term “impinges” means that the secondary laser beam 122 is not focused at a particular point on the weld area 128 but is focused over a relatively wider area with an aim to preheat or post heat the weld area 128. As discussed above the laser can easily be configured into desired heating shapes, such as for example, a circular shape or a rectangular shape, depending on the area of the substrate to be impinged upon. As shown in FIG. 1 the secondary laser beam 122 impinges a wider area over the substrate 110 around the weld area 128. In one embodiment, the cross section of the secondary laser beam 122 impinging over the weld area 128 may be circular or rectangular. As discussed above, preheating of the weld area 128 before the welding process may assist the welding laser beam, in this case the primary laser beam 114, in coupling more efficiently with the weld joint 126. In an exemplary embodiment, the secondary laser beam 122 may help in increasing the temperature of the weld area 128 by at least about half the melting temperature of the substrate 110. For example, if the melting temperature of the substrate 110 is about 800 degrees Celsius, preheating the substrate 110 with the secondary laser beam 122 assists in increasing the temperature of the weld area 128 to about 400 degrees Celsius. In one embodiment, the hybrid laser welding system 124 and the secondary laser beam 122 may move over the substrate 110, while the substrate 110 remains stationary. The arrow 130 indicates the direction of movement of the hybrid laser welding system 124 and the secondary laser beam 122. In another embodiment, the substrate 110 may move under the hybrid laser welding system 124 and the secondary laser beam 122, while the hybrid laser welding system 124 and the secondary laser beam 122 remain stationary. The arrow 132 indicates the direction of movement of the substrate 110. In certain embodiments, the hybrid laser welding system 124 and the secondary laser beam 122 and the substrate 110 may move in the respective directions depicted by the arrows 130 and 132 respectively at a relative speed. The relative speed may be such that the welding is affected in the weld area 128.

In one embodiment, the distance between the primary laser beam 114 and the secondary laser beam 122 is such that that the two beams do not interfere with each other while performing their respective functions. In an exemplary embodiment, the primary laser beam 114 is focused at a distance of about 5 millimeters to about 25 millimeters after the secondary laser beam 122. In another embodiment, the primary laser beam 114 is focused at a distance of about 8 millimeters to about 22 millimeters after the secondary laser beam 122. In yet another embodiment, the primary laser beam 114 is focused at a distance of about 10 millimeters to about 20 millimeters after the secondary laser beam 122.

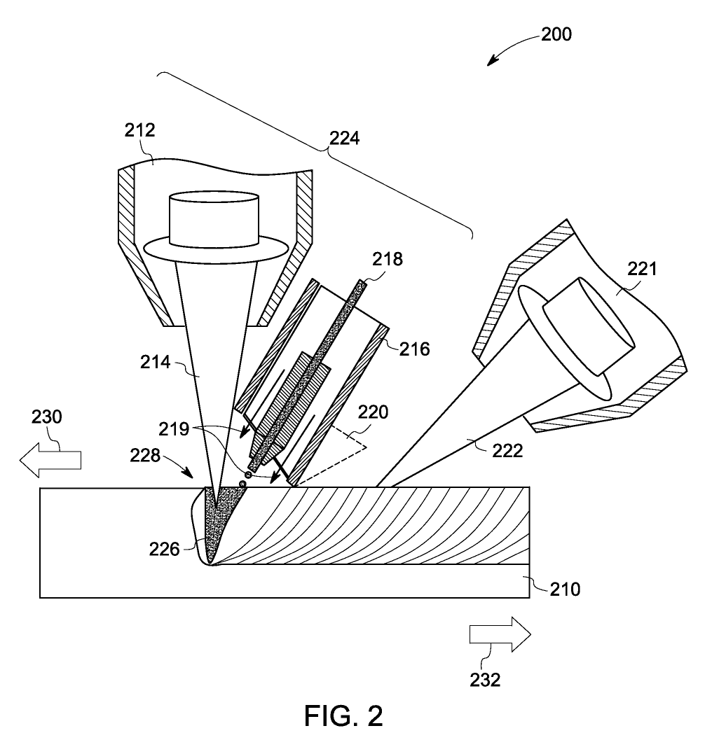

In an illustrated embodiment of the invention as shown in FIG. 2, a welding apparatus 200 is depicted. In the illustrated embodiment, the welding apparatus 200 is used to perform a welding operation on a substrate 210. The welding apparatus 200 includes a primary laser generator 212 for emitting a primary laser beam 214, an arc welding power source 216, a consumable filler electrode 218, a nozzle 220 for passing shielding gas (not shown in figure), a source of shielding gas 219 surrounding the consumable filler electrode 218, and at least one secondary laser generator 221 for emitting a secondary laser beam 222. The primary laser generator 212, the arc welding power source 216, and the consumable filler electrode 218 together form a hybrid laser welding system 224. A weld joint 226 is formed at a weld area 228 in the substrate 210. In the embodiment illustrated in FIG. 2, the secondary laser beam 222 impinges on the substrate 210 after focusing the hybrid laser welding system 224 at the weld area 228, wherein the secondary laser beam 222 post heats the weld area 228 after the hybrid laser welding system 223 comes in contact with the weld area 228. In one embodiment, the hybrid laser welding system 224 and the secondary laser beam 222 may move over the substrate 210, while the substrate 210 remains stationary. The arrow 230 indicates the direction of movement of the hybrid laser welding system 224 and the secondary laser beam 222. In another embodiment, the substrate 210 may move under the hybrid laser welding system 224 and the secondary laser beam 222, while the hybrid laser welding system 224 and the secondary laser beam 222 remain stationary. The arrow 232 indicates the direction of the movement of the substrate 210. In certain embodiments, the hybrid laser welding system 224 and the secondary laser beam 222 and the substrate 210 may move in the respective directions depicted by the arrows 230 and 232 respectively at a relative speed. The relative speed may be such that the welding is affected in the weld area 228.

As mentioned above, post weld heating of the weld joint 226 after the welding process may assist in minimizing residual stresses that may occur in the weld area 228 after the welding process due to thermal stresses within the substrate 210 during weld solidification. Heating the welded region anneals the weld area 228 and may be carried out with respect to particular consumable material and substrate combinations. The amount of heat imparted and the temperature achieved will depend upon particular substrate-consumable material combination and the resultant properties desired. In an exemplary embodiment, the secondary laser beam 222 increases the temperature of the weld area 228 by at least about half the melting temperature of the material as explained above. In an exemplary embodiment, the primary laser beam 214 is focused at a distance of about 5 millimeters to about 25 millimeters before the secondary laser beam 222. In another embodiment, the primary laser beam 214 is focused at a distance of about 8 millimeters to about 22 millimeters before the secondary laser beam 222. In yet another embodiment, the primary laser beam 214 is focused at a distance of about 10 millimeters to about 20 millimeters before the secondary laser beam 222.

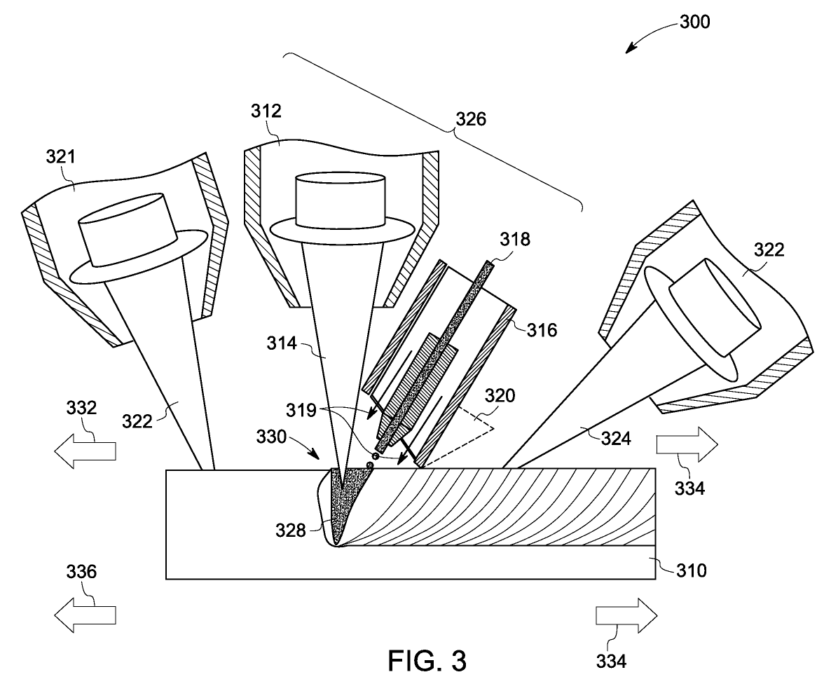

In an illustrated embodiment of the invention as shown in FIG. 3, a welding apparatus 300 is depicted. In the illustrated embodiment, the welding apparatus 300 is used to perform a welding operation on a substrate 310. The welding apparatus 300 includes a primary laser generator 312 for emitting a primary laser beam 314, an arc welding power source 316, a consumable filler electrode 318, a nozzle 320 for passing shielding gas (not shown in figure), a source of shielding gas 319 surrounding the consumable filler electrode 318, and two secondary laser generators 321 and 323 for emitting a first secondary laser beam 322 and a second secondary laser beam 324 respectively. The primary laser generator 312, the arc welding power source 316, and the consumable filler electrode 318 together form a hybrid laser welding system 326. A weld joint 328 is formed at a weld area 330 in the substrate 310. In the embodiment illustrated in FIG. 3, the first secondary laser beam 322 impinges on the substrate 310 before the hybrid laser welding system 326 and the second secondary laser beam 324 impinges on the substrate 310 after focusing the hybrid laser welding system 326. Again as discussed above, since the weld area 330 is being selectively preheated and post heated the weld joint 328 may stay at an elevated temperature even longer. As a result, the weld joint 328 may stay at an elevated temperature following solidification of the weld area 330, thus minimizing the tendency of crack formation in crack sensitive materials. In one embodiment, the apparatus 300 provided in FIG. 3 can alternatively operate in both directions, thereby permitting the system to operate in either direction with preheating or post weld heating or both.

In one embodiment, the hybrid laser welding system 326, the first secondary laser beam 322 and the second secondary laser beam 324 may move over the substrate 310, while the substrate 310 remains stationary. In one embodiment, the first secondary laser beam 322 functions as the preheating laser beam and the second secondary laser beam 324 functions as the post weld heating laser beam, wherein the direction of the movement of the hybrid laser welding system 326, the first secondary laser beam 322 and the second secondary laser beam 324 is indicated by the arrow 332. In another embodiment, the first secondary laser beam 322 may function as the post weld heating laser beam and the second laser beam 324 may function as the preheating laser beam, wherein the direction of the movement of the hybrid laser welding system 326, the first secondary laser beam 322 and the second secondary laser beam 324 is indicated by the arrow 334. In another embodiment, the substrate 310 may move under the hybrid laser welding system 326, the first secondary laser beam 322 and the second secondary laser beam 324, while the hybrid laser welding system 326, the first secondary laser beam 322 and the second secondary laser beam 324 remain stationary. In one embodiment, when the direction of movement of the substrate 310 is indicated by the arrow 336, the first secondary laser beam 322 functions as the preheating laser beam and the second secondary laser beam 324 functions as the post weld heating laser beam. In another embodiment, when the direction of the substrate 310 is indicated by the arrow 338, the first secondary laser beam 322 may function as the post weld heating laser beam and the second laser beam 324 may function as the preheating laser beam. In certain embodiments, the hybrid laser welding system 324, the first secondary laser beam 322, and the second laser beam 324, and the substrate 310 may move in the respective directions at a relative speed, such that welding is affected in the weld area 330.

In one embodiment, the first secondary laser beam 322 and the second secondary laser beam 324 have the same wavelength. In another embodiment, the first secondary laser beam 322 and the second secondary laser beam 324 have a different wavelength. In one embodiment, the first secondary laser beam 322 and the second secondary laser 324 beam have a wavelength in a range from about 600 nanometers to about 900 nanometers. In another embodiment, the first secondary laser beam 322 and the second secondary laser beam 324 have a wavelength in a range from about 650 nanometers to about 850 nanometers. In yet another embodiment, the first secondary laser beam 322 and the second secondary laser beam 324 have a wavelength in a range from about 700 nanometers to about 800 nanometers.

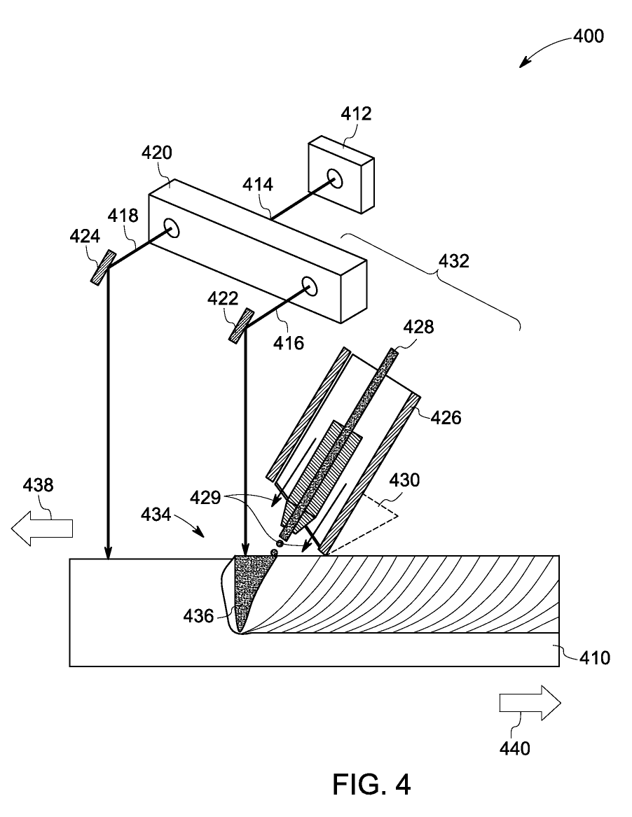

In one embodiment, a single laser generator may be employed in place of the primary laser generator 112 and the secondary laser generator 121. In an illustrated embodiment of the invention as shown in FIG. 4, a welding apparatus 400 is depicted. In the illustrated embodiment the welding apparatus 400 is used to perform a welding operation on a substrate 410. The welding apparatus 400 includes a single laser generator 412 that emits a single laser beam 414. The single laser beam 414 is then split into a primary laser beam 416 and a secondary laser beam 418 using a beam splitting element 420. The primary laser beam 416 and the secondary laser beam 418 are then focused over the substrate 410 using reflectors 422 and 424 respectively. The apparatus 400 further includes, an arc welding power source 426, a consumable filler electrode 428, a nozzle 430 for passing shielding gas (not shown in figure), and a source of shielding gas 429 surrounding the consumable filler electrode 428. A weld joint 436 is formed at a weld area 434 in the substrate 410. The section of the beam splitting element 420 providing the primary laser beam 416, the arc welding power source 426, and the consumable filler electrode 428 may together be considered to form a hybrid laser welding system 432. The secondary laser beam 418 provided by the beam splitting element 420 and the hybrid laser welding system 432 are so located such that the secondary laser beam 418 impinges on the substrate 410 before focusing the hybrid laser welding system 432 at the weld area 434, wherein the secondary laser beam 418 preheats the weld area 434 before the hybrid laser welding system 432 comes in contact with the weld area 434. In one embodiment, the hybrid laser welding system 432 and the secondary laser beam 418 may move over the substrate 410, while the substrate 410 remains stationary. The arrow 438 indicates the direction of movement of the hybrid laser welding system 432 and the secondary laser beam 418. In another embodiment, the substrate 410 may move under the hybrid laser welding system 432 and the secondary laser beam 418, while the hybrid laser welding system 432 and the secondary laser beam 418 remain stationary. The arrow 440 indicates the direction of movement of the substrate 410. In certain embodiments, the hybrid laser welding system 432 and the secondary laser beam 418 and the substrate 410 may move in the respective directions depicted by the arrows 438 and 440 respectively at a relative speed. The relative speed may be such that the welding is affected in the weld area 434.

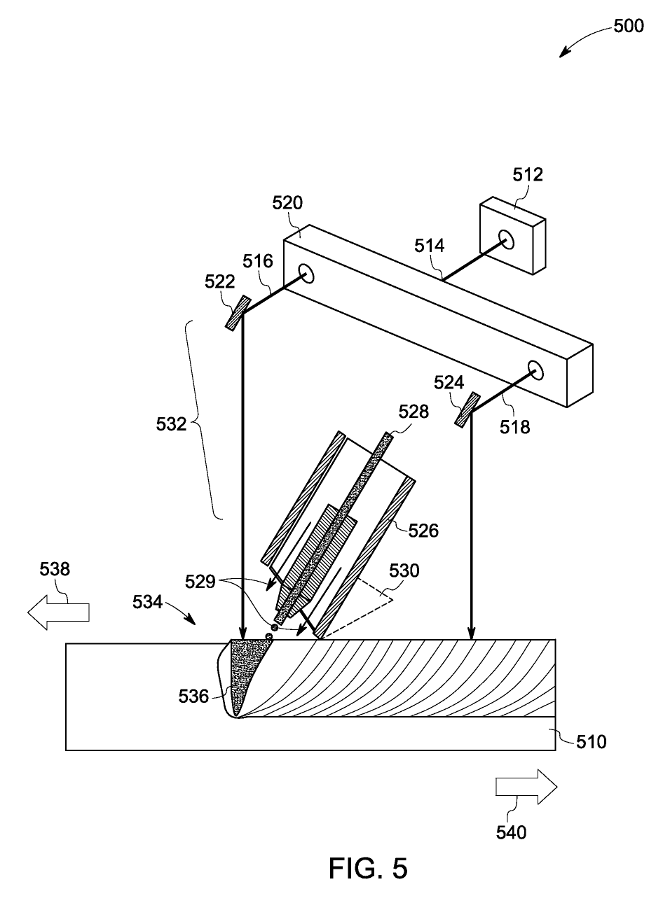

In an illustrated embodiment of the invention as shown in FIG. 5, a welding apparatus 500 is depicted. In the illustrated embodiment the welding apparatus 500 is used to perform a welding operation on a substrate 510. The welding apparatus 500 includes a single laser generator 512 that emits a single laser beam 514. The single laser beam 514 is then split into a primary laser beam 516 and a secondary laser beam 518 using a beam splitting element 520. The primary laser beam 516 and the secondary laser beam 518 are then focused over the substrate 510 using reflectors 522 and 524 respectively. The apparatus 500 further includes, an arc welding power source 526, a consumable filler electrode 528, a nozzle 530 for passing shielding gas (not shown in figure), and a source of shielding gas 529 surrounding the consumable filler electrode 528. A weld joint 536 is formed at a weld area 534 in the substrate 510. The section of the beam splitting element 520 providing the primary laser beam 516, the arc welding power source 526, and the consumable filler electrode 528 may together be considered to form a hybrid laser welding system 532. The secondary laser beam 518 provided by the beam splitting element and the hybrid laser welding system 532 are so located such that the secondary laser beam 518 impinges on the substrate 510 after focusing the hybrid laser welding system 532 at the weld area 534, wherein the secondary laser beam 518 post heats the weld area 534 after the hybrid laser welding system 532 comes in contact with the weld area 534. In one embodiment, the hybrid laser welding system 532 and the secondary laser beam 518 may move over the substrate 510, while the substrate 510 remains stationary. The arrow 540 indicates the direction of movement of the hybrid laser welding system 532 and the secondary laser beam 518. In another embodiment, the substrate 510 may move under the hybrid laser welding system 532 and the secondary laser beam 518, while the hybrid laser welding system 532 and the secondary laser beam 518 remain stationary. The arrow 540 indicates the direction of movement of the substrate 510. In certain embodiments, the hybrid laser welding system 532 and the secondary laser beam 518 and the substrate 510 may move in the respective directions depicted by the arrows 538 and 540 respectively at a relative speed. The relative speed may be such that the welding is affected in the weld area 534.

In the above discussed embodiments, the nozzle 120, 220, 320, 430, and 530 employed may include conventional shield gas arrangements. Conventional arc welders typically employ shield gases such as argon or helium for shielding the laser pulse, the welding arc or both. In certain embodiments methods and apparatus for providing these gases known to one skilled in the art may be employed. Also, in the above discussed embodiments, the arc welding power source 116, 216, 316, 426, 526, employed may include arc welding power sources known to one skilled in art, such as for example, gas metal arc.

In yet another embodiment, a welding method is provided. The welding method includes the steps of providing a primary laser generator 112 for emitting a primary laser beam 114, providing an arc welding power source 116, providing a consumable filler electrode 118, and providing at least one secondary laser generator 121 for emitting a secondary laser beam 122. The primary laser generator 112, the arc welding power source 114 and the consumable filler electrode 116 together form a hybrid laser welding system 124.

In still yet another embodiment, a welding apparatus is provided. The welding apparatus includes a primary laser generator for emitting a primary laser beam, wherein the primary laser generator is selected from one or more of neodymium:yttrium-aluminum-garnet laser, ytterbium fiber coupled diode laser, and carbon dioxide lasers; and a secondary laser generator for emitting a secondary laser beam, wherein the secondary laser generator is selected from one or more of neodymium:yttrium-aluminum-garnet laser, ytterbium fiber coupled diode laser, and carbon dioxide lasers; wherein the secondary laser beam impinges on a weld area before focusing the hybrid laser welding system at the weld area, after focusing the hybrid laser welding system at the weld area, or before and after focusing the hybrid laser welding system at the weld area. As discussed above in various embodiments, the primary laser beam and the secondary laser beam may have the same or different wavelengths.

In still yet another embodiment, a welding method is provided. The welding method includes the steps of providing a primary laser generator for emitting a primary laser beam, wherein the primary laser generator is selected from one or more of neodymium:yttrium-aluminum-garnet laser, ytterbium fiber coupled diode laser, and carbon dioxide lasers, and providing a secondary laser generator for emitting a secondary laser beam, wherein the secondary laser generator is selected from one or more of neodymium:yttrium-aluminum-garnet laser, ytterbium fiber coupled diode laser, and carbon dioxide lasers; wherein the secondary laser beam impinges on a weld area before focusing the hybrid laser welding system at the weld area, after focusing the hybrid laser welding system at the weld area, or before and after focusing the hybrid laser welding system at the weld area

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding apparatus comprising:
a primary laser generator for emitting a primary laser beam;
an arc welding power source;
a consumable filler electrode; and
at least one secondary laser generator for emitting a secondary laser beam;
wherein the primary laser generator, the arc welding power source, and the consumable filler electrode together form a hybrid laser welding system.

2. The welding apparatus of claim 1, wherein the primary laser beam and the secondary laser beam have a same wavelength.

3. The welding apparatus of claim 2, wherein the primary laser beam and the secondary laser beam have a wavelength in a range from about 1060 nanometers to about 10060 nanometers.

4. The welding apparatus of claim 1, wherein the primary laser beam and the secondary laser beam have a different wavelength.

5. The welding apparatus of claim 4, wherein the primary laser beam has a wavelength in a range from about 1060 nanometers to about 10060 nanometers.

6. The welding apparatus of claim 4, wherein the secondary laser beam has a wavelength in a range from about 600 nanometers to about 900 nanometers.

7. The welding apparatus of claim 1, wherein the secondary laser beam impinges on the substrate before focusing the hybrid laser welding system at the weld area.

8. The welding apparatus of claim 7, wherein the secondary laser beam preheats the weld area before the hybrid laser welding system comes in contact with the weld area.

9. The welding apparatus of claim 7, wherein the primary laser beam is focused at a distance in a range of about 5 millimeters to about 25 millimeters from the secondary laser beam.

10. The welding apparatus of claim 1, wherein the secondary laser beam is focused on a weld area after focusing the hybrid laser welding system at the weld area.

11. The welding apparatus of claim 10, wherein the secondary laser beam heats the weld area after the hybrid laser welding system comes in contact with the weld area.

12. The welding apparatus of claim 10, wherein the secondary laser beam impinges at a distance in a range of about 5 millimeters to about 25 millimeters from the primary laser beam.

13. The welding apparatus of claim 1,
wherein a first secondary laser beam impinges on a weld area before the hybrid laser welding system; and
wherein a second secondary laser beam impinges on a weld area after focusing the hybrid laser welding system.

14. The welding apparatus of claim 13, wherein the first secondary laser beam and the second secondary laser beam have the same wavelength.

15. The welding apparatus of claim 13, wherein the first secondary laser beam and the second secondary laser beam have a different wavelength.

16. The welding apparatus of claim 1,
wherein a second secondary laser beam impinges on a weld area before the hybrid laser welding system; and
wherein a first secondary laser beam impinges on a weld area after focusing the hybrid laser welding system.

17. The welding apparatus of claim 16, wherein the first secondary laser beam and the second secondary laser beam have the same wavelength.

18. The welding apparatus of claim 16, wherein the first secondary laser beam and the second secondary laser beam have a different wavelength.

19. The welding apparatus of claim 1, wherein the primary laser generator comprises laser generators selected from one or more of neodymium:yttrium-aluminum-garnet laser, ytterbium fiber coupled diode laser, and carbon dioxide lasers.

20. The welding apparatus of claim 1, wherein the secondary laser generator comprises laser generators selected from one or more of a diode laser selected from neodymium:yttrium-aluminum-garnet laser, ytterbium fiber coupled diode laser, and carbon dioxide lasers.

21. A welding apparatus comprising:
a primary laser generator for emitting a primary laser beam;
an arc welding power source;
a consumable filler electrode; and
at least one secondary laser generator for emitting a secondary laser beam;
wherein the primary laser generator, the arc welding power source, and the consumable filler electrode together form a hybrid laser welding system; and
wherein the secondary laser beam impinges on a weld area before focusing the hybrid laser welding system at the weld area.

22. A welding apparatus comprising:
a primary laser generator for emitting a primary laser beam;
an arc welding power source;
a consumable filler electrode; and
at least one secondary laser generator for emitting a secondary laser beam;
wherein the primary laser generator, the arc welding power source and the consumable filler electrode together form a hybrid laser welding system; and
wherein the secondary laser beam impinges on a weld area after focusing the hybrid laser welding system at the weld area.

23. A welding apparatus comprising:
a single laser generator for emitting a single laser beam;
a beam splitting apparatus to split the single laser beam into a primary laser beam and a secondary laser beam;
an arc welding power source; and
a consumable filler electrode;
wherein a portion of the beam splitting apparatus emitting the primary laser beam, the arc welding power source, and the consumable filler electrode together form a hybrid laser welding system.

24. A welding method comprising:
providing a primary laser generator for emitting a primary laser beam;
providing an arc welding power source;
providing a consumable filler electrode; and
providing at least one secondary laser generator for emitting a secondary laser beam;
wherein the primary laser generator, the arc welding power source and the consumable filler electrode together form a hybrid laser welding system.

25. The method of claim 24, wherein the secondary laser beam impinges on a weld area before focusing the hybrid laser welding system at the weld area.

26. The method of claim 24, wherein the secondary laser beam impinges on a weld area after focusing the hybrid laser welding system at the weld area.

27. The method of claim 24, comprising a first secondary laser generator for emitting a first secondary laser beam and a second secondary laser generator for emitting a second secondary laser beam.

28. The method of claim 27, wherein a first secondary laser beam impinges on a weld area before the hybrid laser welding system; and
wherein a second secondary laser beam impinges on a weld area after focusing the hybrid laser welding system.

29. A welding apparatus comprising:
a primary laser generator for emitting a primary laser beam, wherein the primary laser generator is selected from one or more of neodymium:yttrium-aluminum-garnet laser, ytterbium fiber coupled diode laser, and carbon dioxide lasers; and
a secondary laser generator for emitting a secondary laser beam, wherein the secondary laser generator is selected from one or more of neodymium:yttrium-aluminum-garnet laser, ytterbium fiber coupled diode laser, and carbon dioxide lasers;
wherein the secondary laser beam impinges on a weld area before focusing the primary laser beam at the weld area, after focusing the primary laser beam at the weld area, or before and after focusing the primary laser beam at the weld area

30. The welding apparatus of claim 29, wherein the primary laser beam and the secondary laser beam have a same wavelength.

31. The welding apparatus of claim 30, wherein the primary laser beam and the secondary laser beam have a wavelength in a range from about 1060 nanometers to about 10060 nanometers.

32. The welding apparatus of claim 29, wherein the primary laser beam and the secondary laser beam have a different wavelength.

33. The welding apparatus of claim 32, wherein the primary laser beam has a wavelength in a range from about 1060 nanometers to about 10060 nanometers.

34. The welding apparatus of claim 32, wherein the secondary laser beam has a wavelength in a range from about 600 nanometers to about 900 nanometers.
